(19) United States
(12) Patent Application Publication
(10) Pub. No.: US 2008/0124015 A1
(43) Pub. Date: May 29, 2008

(54) BEARING ROLLER CHAIN

(76) Inventors: Makoto FUJIWARA, Osaka (JP); Makoto Tanimura, Osaka (JP); Tetsuo Imamoto, Osaka (JP)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/861,444

(22) Filed: Sep. 26, 2007

(30) Foreign Application Priority Data
Nov. 27, 2006 (JP) 2006-319354

(51) Int. Cl. F16C 33/76

(52) U.S. Cl. 384/484

(57) ABSTRACT

A bearing roller chain having a seal mechanism preventing entry of foreign substance from the outside, and leaking of lubricating oil leakage to the outside and the like, thereby improving wear resistance of the bearing roller and reducing both the likelihood of rotation failure and the traveling resistance of the chain. The seal mechanism is provided between an inner link plate of the chain and the hollow bearing roller, which has a plurality of internal anti-friction rollers rotatable between the hollow bearing roller and a bush mounted between opposed inner link plates. The seal mechanism encloses the internal anti-friction rollers and comprises two parts, i.e a seal ring having an annular lip portion, which comes into close contact with an outer side surface of the bearing roller and an annular metallic seal member. The metallic seal member forms a labyrinth structure by providing a flange on an outer circumferential portion which loosely enters an annular concave groove in the outer side surface of the bearing roller. The seal mechanism provides a double sealing effect by virtue of the seal ring and the annular metallic seal member.

### FIELD OF INVENTION

The present invention relates to a bearing roller chain used in a transmission chain, which transmits power, a conveyor chain or the like, and more specifically relates to a bearing roller chain, in which a double seal mechanism composed of a seal ring and an annular metallic seal member is provided between a hollow bearing roller and an inner link plate to prevent the entry of foreign substances such as dust, water and the like to the hollow interior of the bearing roller so that wear resistance of the bearing roller is improved.

### BACKGROUND OF THE INVENTION

Since the bearing roller chain is adapted to high speed, high load in a case of the transmission of power, it has been widely used as a high speed transmission chain and a conveyor chain. And in the use of the bearing roller chain in an atmosphere of dust, an atmosphere of water splashing or the like, a seal mechanism is provided between an inner link plate and a bearing roller in a chain to prevent entry of foreign substances between the bearing roller and an interior bush, to prevent the scattering of grease or oil sealed from between the bearing roller and the bush and the like. Various seal mechanisms have been proposed.

FIG. 6 shows an example of a conventional bearing roller chain in an enlarged manner. The bearing roller chain 21 provides inward flanges 22b on both sides of a first hollow roller 22. A number of anti-friction rollers 24 are disposed between the first roller 22 and a bush 23 and a thrust ring 27 composed of a low friction, wear resistant synthetic resin and an oleo-sintered metal as a seal mechanism is provided between the roller 22 and an inner link plate 25. Further, a lubricating oil filled space 28 is provided inside the thrust ring 27. It is noted that the reference numeral 26 denotes an outer link plate and the reference numeral 29 denotes a connecting pin (see Japanese Patent Publication No. Hei. 4-78523)

In the above-described conventional bearing roller chain, the seal mechanism 22 is one-layered structure composed of a thrust ring 27 provided between a first roller 22 and an inner link plate 25. The seal performance is not sufficient and when the thrust ring 27 has a low close contact with the roller 22 and/or the inner link plate 25, lubricating oil can leak out of space between an end surface of the roller 22 and the thrust ring 27. Further, there is a problem that foreign substance such as dust, water or the like enters through the gap to mix into the lubricating oil, so that wear of the roller 22, the bush 23, the anti-friction roller 24 and the like is promoted, resulting in failure of the roller's rotation. This results in that the wear life of the chain is shortened. In this case, there is a problem that when close clearance properties are increased not so as to generate space between the thrust ring 27 and the roller 22 or the inner link plate 25, traveling resistance of the chain is increased and the power required to drive the conveyor is increased.

### SUMMARY OF THE INVENTION

Accordingly, the object of the present invention is to solve the above-mentioned prior art problems and to provide a bearing roller chain, in which the seal performed the like. In addition, an improvement of wear life of the bearing roller and the suppression of rotation failure of the roller can be effected without increasing the traveling resistance of the chain.

The present invention solves the problems by providing a bearing roller chain having a first roller mounted on a bush by anti-friction rollers. Both end portions of the bush are fit-secured into bush holes of a pair of inner link plates and a seal mechanism is provided between the inner link plate and the first roller. The first roller has inward flanges on both inner circumferential sides, a plurality of second anti-friction rollers disposed between the first roller and said bush in parallel with the center axial line of the bush, and a seal mechanism with side rings, which fit over said bush on an inner circumferential side and at one end in close contact with the side surfaces of said second anti-friction rollers and at the other end in close contact with an inner surface of said inner link plate, are respectively provided on both sides of said bearing roller. The seal mechanism comprises a resin or rubber seal ring having an annular lip portion, which projects into close contact with an outer side surface of said first roller, and an annular metallic seal member provided between the inner link plate and a side surface of said first roller while covering the seal ring. At its outer end, the annular metallic seal member includes a flange, which enters an annular concave groove concentrically formed on an outer side surface of said first roller.

According to another feature of the present invention, the annular metallic seal member comprises an inner annular portion, which is mounted on one of the side rings, and which on the outer circumferential side engages the seal ring to hold it. A disk-shaped portion extends substantially vertically from a side end of the inner annular portion and comes into close contact with an inner surface of said inner link plate. A frusto-conical portion in a gradually widened manner extends from an outer circumferential edge of said disk-shaped portion. The frusto-conical portion terminates in a flange extending loosely into an annular groove concentrically formed on an outer side surface of said roller.

In the bearing roller chain of the present invention, the bearing roller comprises a first roller having inward flanges on both inner circumferential sides, a plurality of second anti-friction rollers disposed between the first roller and the bush in parallel with the center axial line of the bush, and side rings, which on their inner circumferential sides mounted on the bush, and on their outer sides come into close contact with the opposite ends of the second anti-friction rollers and an inner surface of the inner link plates respectively provided on both sides of said bearing roller. These elements prevent an axial shift of the bearing roller positioned and mounted between a pair of inner link plates.

The seal mechanism comprises a resin or rubber seal ring having an annular lip portion, which comes into close contact with an outer side surface of the first roller and an annular metallic seal member provided between said inner link plate and a side surface of said first roller while covering said seal ring, the seal mechanism is formed to be a double seal mechanism composed of a seal ring and an annular metallic seal member. Thus sufficient seal performance can be ensured, and as the result even in various use environments such as in a dust atmosphere, in an atmosphere of water splashing and the like, the invasion of foreign substance inside the bearing roller can be prevented and at the same time prevention of leakage of lubricating oil into the outside can be effected. Further, since the prevention of invasion of foreign substance is possible, the wear resistant life of the bearing roller can be improved, suppression of rotation failure of the roller can be effected and an increase in the traveling resistance of the chain can be suppressed.

The annular metallic seal member includes a flange, which loosely enters an annular concave groove concentrically formed on an outer side surface of the first roller with space in an outer circumferential portion. The annular concave groove and flange cooperate to form a labyrinth structure which suppresses the invasion of foreign substance into a seal ring side of the seal mechanism. Thus the endurance of the seal ring can be improved and no loss of wear resistance between the roller and the metallic seal member occurs.

The aforedescribed annular metallic seal member can be integrally formed, and can prevent the invasion of foreign substance from the outside and the seal ring can be held inside the metallic seal member with the seal ring covered.

In a case where particularly a double seal structure is formed of the metallic seal member and the seal ring held inside, a labyrinth structure is formed of the annular concave groove and the flange. This labyrinth structure and the seal ring provided inside can further improve the seal performance, and the invasion of foreign substance from the outer portion to the inside of the bearing roller and leakage of stored lubricating oil from inside the bearing roller to the outside can be prevented.

### BRIEF DESCRIPTION OF THE DRAWINGS

The invention will be described in further detail in connection with the drawings in which

Fig. I is a partial plan view of a bearing roller chain;

FIG. 2 is a partial side view of the bearing roller chain;

FIG. 3 is a cross-sectional view through the hollow bearing roller of the bearing roller chain;

FIG. 4 is an enlarged cross-sectional view of a principal portion of a seal mechanism;

FIG. 5 is a further enlarged cross-sectional view of a principal portion of a seal mechanism in a modified embodiment of the bearing roller chain; and

FIG. 6 is a view partially in cross-section of the hollow bearing roller in a conventional bearing roller chain.

### DESCRIPTION OF PREFERRED EMBODIMENTS OF THE INVENTION

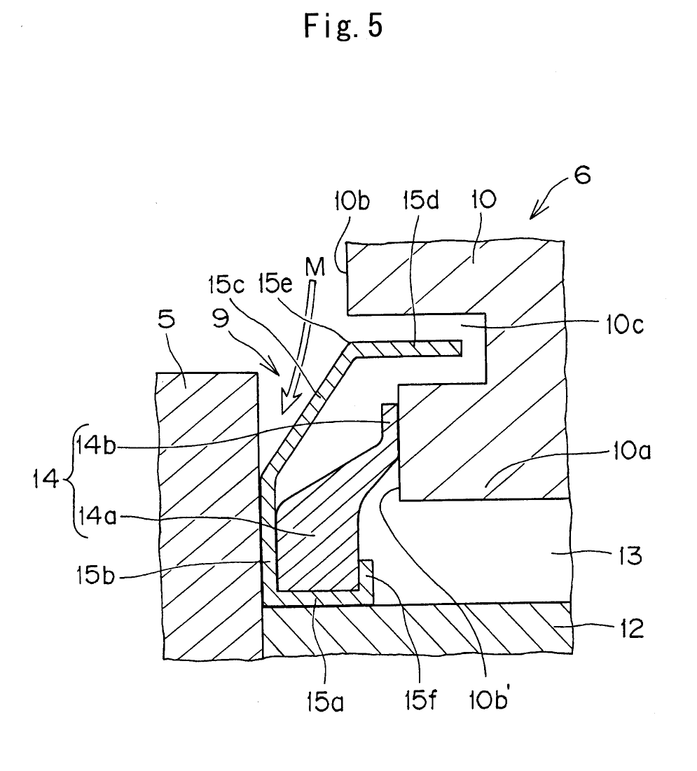

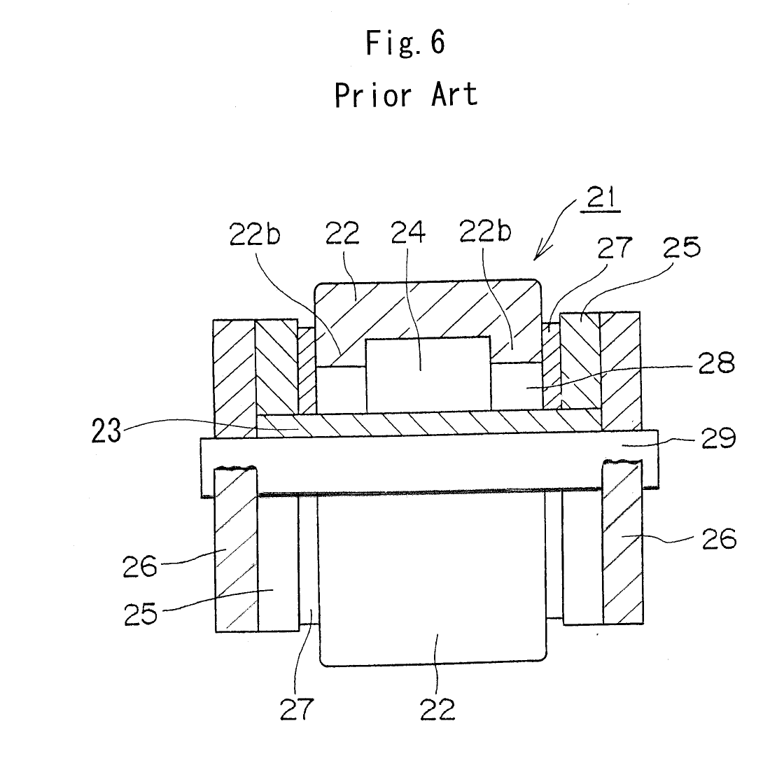

Examples of the present invention will be described. FIGS. 1 to 4 illustrate a first embodiment, an FIG. 5 is an enlarged cross-sectional view of a principal portion of a seal mechanism in a modified example of the bearing roller chain.

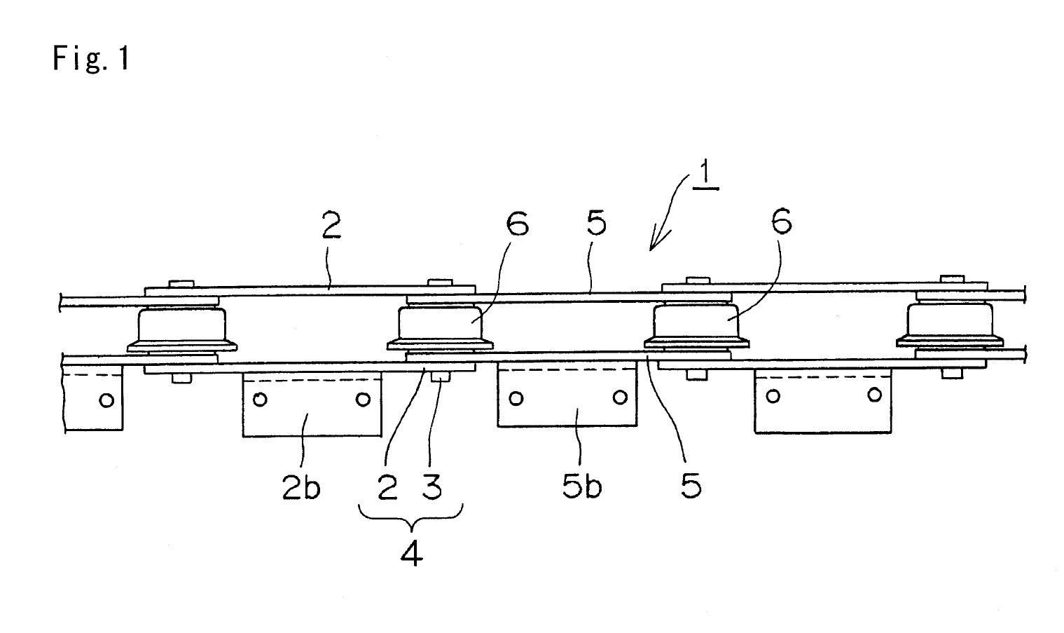

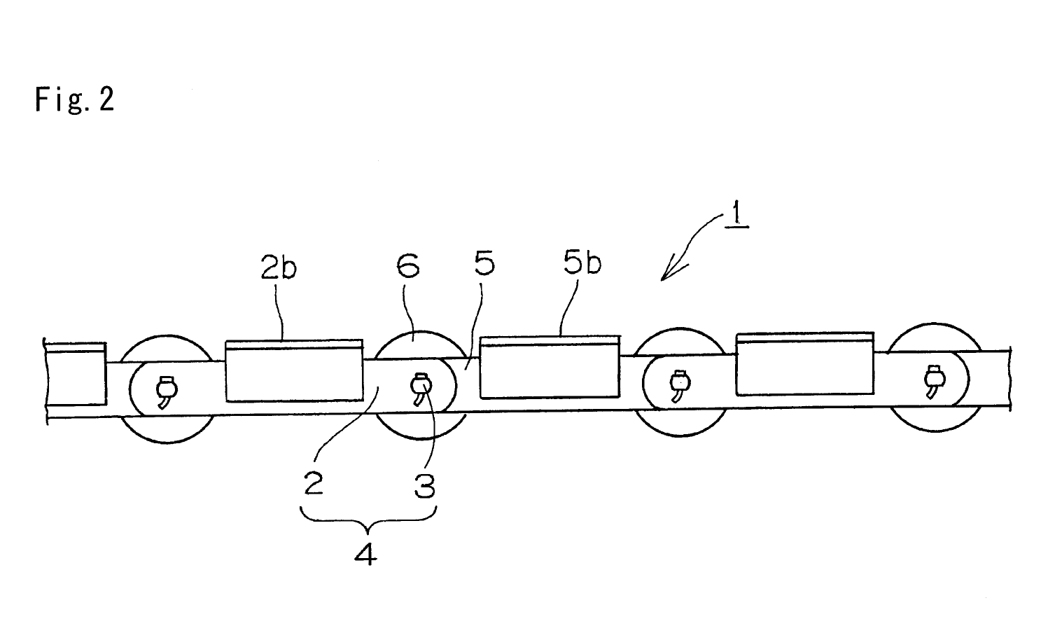

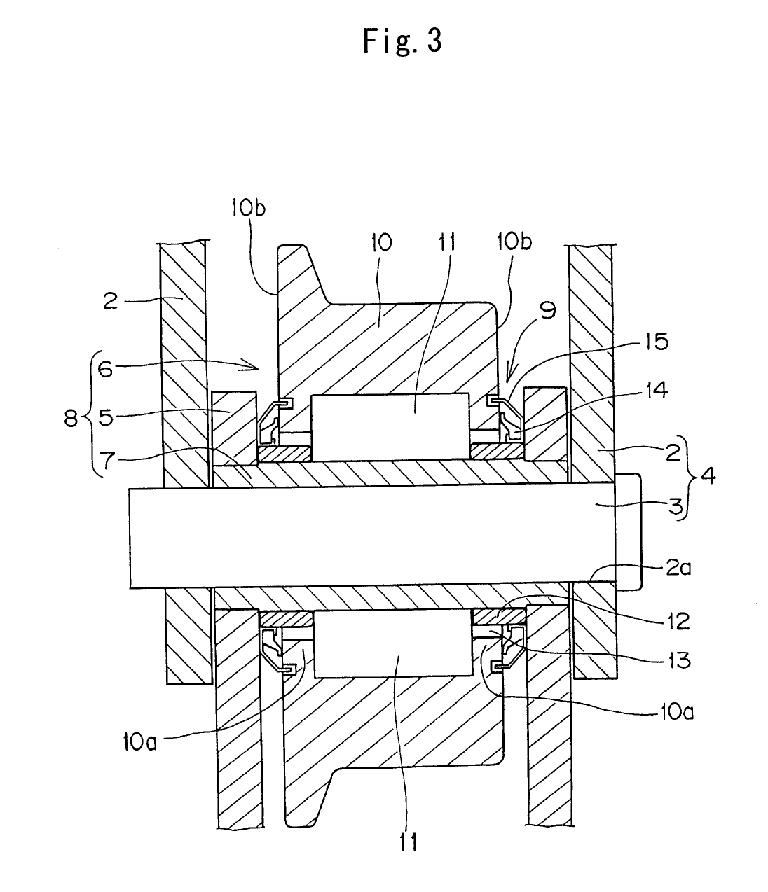

In a bearing roller chain I, as shown in FIGS. 1,2, and 3, an outer link 4 consists of a pair of outer link plates 2,2 and a connecting pin 3. Both end portions of the connecting pin 3 are fit-secured to pin holes 2a in the pair of outer link plates 2, 2. The chain includes inner links 8 (FIG. 3) in which both end portions of a bearing roller-mounted bush 7 are fit-secured to bush holes 5a of a pair of inner link plates 5, 5. The inner and outer links 8 and 4 are endlessly connected to each other by loosely fitting the connecting pins 3 into the bush 7, and as shown in FIG. 3, a seal mechanism 9 is provided between the inner link plate 5 and a bearing roller 6. It is noted that the reference numerals 2b and 5b in FIGS. 1 and 2 denote attachments mounted on the outer link plate 2 and the inner link plate 5, respectively.

In the connecting pin 3 an oil passage (not shown) may be formed inside so that a lubricating oil or grease or the like may be supplied between the outer circumferential surface of the connecting pin 3 and the inner circumferential surface of the bush 7. Alternatively, a previous oil supply may be incorporated inside the structure during assembly of the can, or an oil supply structure may not be provided.

The bearing roller 6 comprises, as shown in FIG. 3, a first roller 10 having inward flanges 10a on inner circumferential surface sides, which roller functions as an outer race of a roller bearing, a bush 7, which functions as an inner race, and a plurality of anti-friction rollers 11 disposed between the roller 10 and the bush 7 in parallel with the axial center line of the bush 7

On each side the bearing roller 6 a side ring 12 is mounted on the bush between an end surface 11a of the anti-friction roller 11 and an inner surface of the inner link plate 5. The ring is fitted to the bush 7 in a press-fit or loosely fit manner. When this side ring 12 comes into close contact with the end surface 11a of the roller 11 and the inner surface of the inner link plate 6, the anti-friction roller 11 is held by inward flanges 10 of the roller 10 and side rings 12. Thus an axial shift (in a thrust direction) of the bearing roller positioned and mounted between a pair of inner link plates can be prevented.

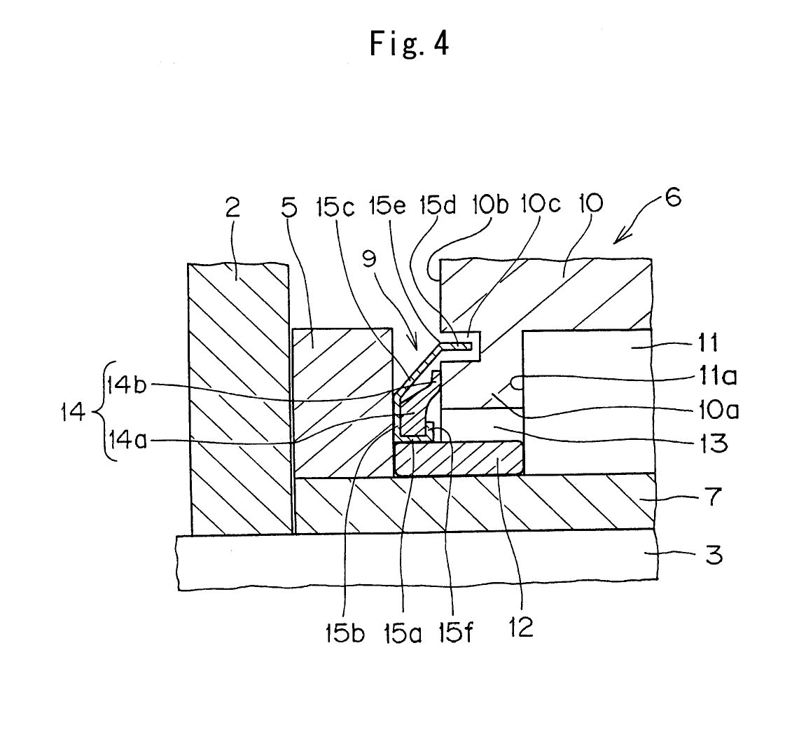

Further, since as mentioned above, the side ring 12 comes into close contact with the side surface 11a of the roller 11, a pocket 13 is provided on both sides of inner circumferential surfaces of the roller 10, between inward flanges 10a, as shown in FIG. 4 the side ring 12, the anti-friction roller 11 and the flange 10a of the roller 10 form an annular pocket 13. This pocket 13 is closely sealed by a seal ring to be described later and functions as a lubricating oil storage space (grease retainer).

The seal mechanism 9 is provided between the inner link plate 5 and the bearing roller 6, and comprises a seal ring 14 having an annular lip portion 14b in close contact with an outer side surface 10b of the roller 10 and an annular metallic seal member 15, which seals between the inner link plate 5 and the roller 10 while covering the seal ring 14 from the outside. It is noted that in the roller in this example the outer side surfaces 10b of both sides are flush with each other except for a concave groove 10c.

This seal ring 14 includes an annular base portion 14a fit-covered with a ring portion 15a of the metallic seal member 15 and an annular lip portion 14b projecting from the base portion 14a on its outer circumferential side, and is formed of the synthetic resin or a synthetic rubber (preferably nitrile rubber, fluororubber) excellent in oil resistance, heat resistance and wear resistance. The annular lip portion 14b of the seal ring 14 comes into slidably close contact with the outer side surface 10b of the roller 10.

The annular metallic seal member 15 includes as shown in FIG. 4 the ring portion 15a fitted onto the side ring 12. The outward-facing side of this ring portion 15a fits and holds the annular base portion 14a of the seal ring 14, and the inward-facing side, the ring portion 15a is mounted onto the side ring 12 by press-fitting or loosely fitting thereto.

On the outer side of the ring portion 15a of the annular metallic seal member 15 a disk-shaped portion 15b extends substantially vertically to the ring portion 15a, and slidably comes into close contact with an inner surface of the inner link plate 5. A frusto-conical portion 15c is extended in a gradually widened manner from the outer circumference of this disk-shaped portion 15b. A flange 15d is extended from the top end outer circumferential edge of the frusto-conical portion 15c toward an annular concave groove 10c concentrically formed on an outer side surface 10b of the roller 10. The junction 15e where the frusto-conical portion 15c and the flange 15d are joined with each other is aligned with outer side surface 10b of the roller 10, i.e. is disposed at a position substantially flush with the outer side surface 10b. As shown in FIG. 4, an upright ring 15f is formed on the inner side edge of the ring portion 15a so that an annular base portion 14a of the seal ring 14 may be held by a concave portion formed between the disk-shaped portion 15b and the upright ring 15f above the ring portion 15a.

The flange 15d of the annular metallic seal member 15 loosely enters the annular concave groove 10c concentrically formed on the outer side surface 10b of the roller 10 to form a labyrinth structure. Further, the annular metallic seal member 15 is preferably integrally formed of steel or stainless steel.

Although a configuration of the bearing roller chain I, which is an example of the present invention, has been explained above, actions and effects of the bearing roller chain I will be described below. In the bearing roller chain I the bearing roller 6 mounted on the bush 7 comprises a first roller 10 having inward flanges 10a on both inner circumferential sides and a plurality of anti-friction rollers 11 disposed in parallel with the center axial line of the bush 7 between the first roller 10 and the bush 7. On each side of the bearing roller 6 a side ring 12 is in close contact with a side surface 11a of the anti-friction roller 11 and an inner surface of the inner link plate 5. Thus since the anti-friction roller 11 included in the bearing roller 10 is held by the flanges 10a formed inward on both inner circumferential sides of the roller and the side rings 12, an axial shift of the bearing roller 6 positioned and mounted between a pair of inner link plates 5, 5 can be prevented.

The seal mechanism 9 comprises a resin or rubber seal ring 14 having an annular lip portion 14b biased into close contact with the outer side surface 10b of the roller 10 and the annular metallic seal member 15 is provided between the inner link plate 5 and the outer side surface 10b of the roller 10 so as to cover the seal ring 14. Thus since the seal mechanism 9 has a double seal mechanism composed of the seal ring 14 and the annular metallic seal member 15, sufficient seal performance can be ensured. As the result even in various use environments such as in a dust atmosphere, in an atmosphere of water splashing and the like, the invasion of foreign substance such as dust, water and the like inside the bearing roller from the outside can be prevented and at the same time prevention of leakage of lubricating oil into the outside can be achieved. Further, since the prevention of invasion of foreign substances is possible, the wear resistance of the bearing roller 6 can be improved, suppression of rotation failure of the roller 10 can be achieved and an increase in the traveling resistance of the chain can be avoided.

Since the annular metallic seal member 15 includes a flange 15d, which enters an annular concave groove 10c concentrically formed on an outer side surface 10b of the roller 10 with space, a labyrinth structure is formed of an annular concave groove 10c and a flange 15d, and this labyrinth structure suppresses the invasion of foreign substance to a seal ring 14 side. In this case since a corner portion 15e where the frusto-conical portion 15c and the flange 15d are joined with each other is substantially the same position as an outer side surface 10b of the roller 10 or disposed in a position substantially flush therewith, the invasion of foreign substance from the outside into the flange 15d-entered concave groove 10c is prevented. As the result the endurability of the seal ring 14 can be improved and no occurrence of wear resistance between the roller 10 and the metallic seal member 15 is made.

Since the annular metallic seal member 15 comprises a ring portion 15a, which fits to the seal ring 14 on an outer circumferential side to hold it and fits to the side rings 12 on an inner circumferential surface side, a disk-shaped portion 15b, which is substantially vertically extended from a side end of the ring portion 15a and comes into close contact with an inner surface of the inner link plate 5, a frusto-conical portion 15c in a gradually widened manner from an outer circumferential edge of the disk-shaped portion 15b, and a flange 15d extended toward an annular groove 10c concentrically formed on an outer side surface 10b of the roller 10 from an top end outer circumferential edge of the frusto-conical portion 15c, in addition, the annular metallic seal member can be integrally formed, even only the annular metallic seal member 15 can prevent the invasion of foreign substance from the outside and the seal ring 14 can be held inside the metallic seal member 15 with the seal ring 14 covered.

In a case where particularly a double seal structure is formed of the metallic seal member 15 and the seal ring 14 held inside, a labyrinth structure is formed of the annular concave groove 10c and the flange 15d. This labyrinth structure and the seal ring 14 provided inside can further improve the seal performance, and the entry of foreign substances from the outside to the inside of the bearing roller 6 and leakage of stored lubricating oil from the inside to the outside can be prevented.

In the seal mechanism 9 since an annular pocket 13 is formed between the roller 11, the flange 10a of the roller 10, and the seal ring 14, this annular pocket 13 can be a lubricating oil retainer (grease retainer), and the lubricity of the bearing roller 6 can be maintained for a long period of time, so that a long life of the chain can be obtained.

Next, a modified example of a bearing roller chain will be described based on FIG. 5. In the bearing roller chain I of the above-mentioned example, the outer side surfaces 10b of the roller 10 are flush with each other except for the concave groove 10c. However, a roller 10 of a bearing roller chain in a modified example has an offset outer side surface I0b′ in which a portion inboard of a concave groove 10c is offset relative to the outboard side surface 10b. The modified example will be described below while common members such as the link plate and the like to those of the above-mentioned example are denoted the same reference numerals.

As shown in FIG. 5, the first roller 10 of a bearing roller 6 has an inward flange 10a. An annular concave groove 10c is formed on an outer side surface 10b of the roller 10, and a portion inboard of the concave groove 10c that is a portion near the bush 7 is offset as indicated at 10b′. A seal mechanism 9 comprises the ring portion 15a and an annular metallic seal member 15, and the seal ring 14 has an annular base portion 14a and an annular lip portion 14b. Further, the annular metallic seal member 15 includes the ring portion 15a, the disk-shaped part 15b, the frusto-conical cylindrical portion 15c and the flange 15d. As in the above-mentioned example, the flange 15d of the annular metallic seal member 15 loosely enters the annular concave groove 10c formed on an outer side surface 10b of the roller 10 to form a labyrinth structure, which maintains the seal performance. In this case, since the junction 15e where the frusto-conical cylindrical portion 15c and the flange 15d are joined to each other, is substantially aligned with the outboard side surface 10b beyond the concave groove 10c of the roller 10 that is a position substantially flush with each other, invasion or entry of foreign substances into the concave groove 10c where the flange 15 enters is prevented. It is noted that diversion of foreign substances from the outside is the same as that of the above-mentioned example, but as shown by an arrow M the foreign substance flows along an outer surface of the frusto-conical portion 15c of the annular metallic seal member 15. Thus, the foreign substance does not enter inside the bearing roller 6. The offset relationship of the inboard side surface 10b′ insures that the junction is flush with the outboard side surface 10b, or is positioned within the concave groove 10c. In FIG. 4 the arrow M is omitted.

1. A bearing roller chain with a pair of inner link plates having bush holes, a bush having both ends fit-secured into said bush holes, a bearing roller rotatable on said bush, and a seal mechanism between each end of said bearing roller and the adjacent inner link plate, wherein
said bearing roller comprises a hollow first roller with an inner circumferential surface with inward flanges at both ends, and end surfaces with an annular concave groove concentric with said bearing, a plurality of second anti-friction rollers disposed between said first roller and said bush in parallel with said bush, and side rings at both ends of said bearing roller, each side ring having an inner periphery an inner circumferential side fit secured to said bush and an outer structure having one side adjacent an end surface of said second anti-friction roller and another side confronting the inner surface of the associated link plate, and
said seal mechanism comprises a seal ring having an annular lip portion, which comes into contact with an outer side surface of said roller and an annular metallic seal member provided between said inner link plate and a side surface of said first roller, said metallic seal member covering said seal ring, said annular metallic seal member including a flange entering said annular concave groove concentrically, thereby forming a labyrinth structure enhancing the performance of said seal mechanism.

2. A bearing roller chain according to claim 1, wherein said outer structure comprises a disk-shaped outer portion adjacent the inner surface of said inner link plate covering the outer circumferential side of said seal ring to hold it, and an inner portion holding the inner circumferential surface side of said seal ring, a frusto-conical portion extending from a said disk-shaped outer portion of said outer structure to adjacent said concave groove, and terminating in said flange entering said annular groove.

3. A bearing roller chain according to claim 2, wherein the junction between said frusto-conical portion and said flange is aligned with an end surface of said first roller adjacent said annular groove.

4. A bearing roller chain according to claim 3, wherein the end surface of said first roller inboard of said annular groove is offset inwardly from the end surface of said first roller outboard of said annular groove.

5. A bearing roller according to claim 1 wherein said metallic seal member comprises stainless steel and said seal ring is composed of a resilient flexible material selected from a rubber and a resin.

6. A bearing roller according to claim 1 wherein said inward flanges define between them an outer raceway for said second anti-friction rollers, and said side rings define between them an inner raceway for said second anti-friction rollers.

7. A bearing roller chain with a pair of inner link plates having bush holes, a bush having both ends fit-secured into said bush holes, a bearing roller rotatable on said bush, and a seal mechanism between each end of said bearing roller and the adjacent inner link plate, wherein
said bearing roller comprises a hollow first roller with an inner circumferential surface with inward flanges at both ends, and end surfaces with an annular concave groove concentric with said bearing, a plurality of second anti-friction rollers disposed between said first roller and said bush in parallel with said bush,
said seal mechanism comprises a seal ring having an annular lip portion, which comes into contact with an outer side surface of said roller and an annular metallic seal member provided between said inner link plate and a side surface of said first roller, said metallic seal member covering said seal ring, said annular metallic seal member including a flange entering said annular concave groove concentrically, thereby forming a labyrinth structure enhancing the performance of said seal mechanism.

8. A bearing roller chain according to claim 7, wherein said outer structure comprises a disk-shaped outer portion adjacent the inner surface of said inner link plate covering the outer circumferential side of said seal ring to hold it, and an inner portion holding the inner circumferential surface side of said seal ring, a frusto-conical portion extending from a said disk-shaped outer portion of said outer structure to adjacent said concave groove, and terminating in said flange entering said annular groove.

9. A bearing roller chain according to claim 8, wherein the junction between said frusto-conical portion and said flange is aligned with an end surface of said first roller adjacent said annular groove.

10. A bearing roller chain according to claim 7, wherein the end surface of said first roller inboard of said annular groove is offset inwardly from the end surface of said first roller outboard of said annular groove.

11. A bearing roller according to claim 7 wherein said metallic seal member comprises stainless steel and said seal ring is composed of a resilient flexible material selected from a rubber and a resin.

12. A bearing roller according to claim 7 wherein said inward flanges define between them an outer raceway for said second anti-friction rollers.
